SEQUENCE LISTING (8 sequences)

SEQ ID NO: 1 - DNA, 1170 bp, Arabidopsis thaliana
atggaggtaatgcgagttcttcacatgaacaaaggaaacggggaaacaagttatgccaagaactccaccgctcagagcaacataatatctctaggcagaagagtaatggacgaggccttgaagaagttaatgatgagcaattcagagatttcgagcattggaatcgccgacttaggctgctcctccggtccgaacagtctcttgtccatctccaacatagttgacacgatccacaacttgtgtcctgacctcgaccgtccagtccctgagctcagagtctctctcaacgacctccctagcaatgacttcaactacatatgtgcttctttgccagagttttacgaccgggttaataataacaaggagggtttagggttcggtcgtggaggaggagaatcgtgttttgtgtcggccgtcccaggttcgttctacggacgtttgtttcctcgccggagccttcactttgtgcattcttcttctagtttacattggttgtctcaggttccatgtcgtgaggcggagaaggaagacaggacaataacagctgatttagaaaacatggggaaaatatacatatcaaagacaagtcctaagagtgcacataaagcttatgctcttcaattccaaactgatttcttggtttttttgaggtcacgatctgaggagttggtcccgggaggccgaatggttttatcgttccttggtagaagatcactggatcccacaaccgaagagagttgctatcaatgggaactcctagctcaagctcttatgtccatggccaaagagggtatcatcgaggaagagaagatcgatgctttcaacgctccttactatgctgcgagctccgaagagttgaaaatggtgatagagaaagaagggtcattttcgatcgataggcttgagataagtccgattgattgggaaggtgggagtatcagtgaggagagttatgaccttgcaataaggtccaaacccgaagccctagctagtggccgaagagtgtctaataccataagagctgtggtcgagccgatgctagaacctactttcggtgaaaatgtgatggacgagctttttgaaaggtatgcaaagatcgtgggagagtacttctatgtaagctcgccacgatacgctattgttattctttcgctcgttagaaccggttga

SEQ ID NO: 2 - DNA, 1476 bp, Arabidopsis thaliana
  CDS (15)..(1181): open reading frame for JMT
aaagagagagagagatggaggtaatgcgagttcttcacatgaacaaaggaaacggggaaacaagttatgccaagaactccaccgctcagagcaacataatatctctaggcagaagagtaatggacgaggccttgaagaagttaatgatgagcaattcagagatttcgagcattggaatcgccgacttaggctgctcctccggtccgaacagtctcttgtccatctccaacatagttgacacgatccacaacttgtgtcctgacctcgaccgtccagtccctgagctcagagtctctctcaacgacctccctagcaatgacttcaactacatatgtgcttctttgccagagttttacgaccgggttaataataacaaggagggtttagggttcggtcgtggaggaggagaatcgtgttttgtgtcggccgtcccaggttcgttctacggacgtttgtttcctcgccggagccttcactttgtgcattcttcttctagtttacattggttgtctcaggttccatgtcgtgaggcggagaaggaagacaggacaataacagctgatttagaaaacatggggaaaatatacatatcaaagacaagtcctaagagtgcacataaagcttatgctcttcaattccaaactgatttcttggtttttttgaggtcacgatctgaggagttggtcccgggaggccgaatggttttatcgttccttggtagaagatcactggatcccacaaccgaagagagttgctatcaatgggaactcctagctcaagctcttatgtccatggccaaagagggtatcatcgaggaagagaagatcgatgctttcaacgctccttactatgctgcgagctccgaagagttgaaaatggtgatagagaaagaagggtcattttcgatcgataggcttgagataagtccgattgattgggaaggtgggagtatcagtgaggagagttatgaccttgcaataaggtccaaacccgaagccctagctagtggccgaagagtgtctaataccataagagctgtggtcgagccgatgctagaacctactttcggtgaaaatgtgatggacgagctttttgaaaggtatgcaaagatcgtgggagagtacttctatgtaagctcgccacgatacgctattgttattctttcgctcgttagaaccggttgatcgtgttataacatatgccaatatacatgtctttgggcctacaatgacatgatttggtagttttctaatcaagcatatgtaatataatttgcttcgagaataaaataataaaataaagtgtgatgttacggtagacccttttttttttttcttcatttacggtagacctatagtattaaaacaaatagaatcagctggttcggaccttgaaatgagagagcttggatgcatgtagacgcattagtcgtgaattattcaaatagaactaccttttgggccaaaaaaaaaaaaa

SEQ ID NO: 3 - protein, 389 aa, Arabidopsis thaliana
MEVMRVLHMNKGNGETSYAKNSTAQSNIISLGRRVMDEALKKLMMSNSEISSIGIADLGCSSGPNSLLSISNIVDTIHNLCPDLDRPVPELRVSLNDLPSNDFNYICASLPEFYDRVNNNKEGLGFGRGGGESCFVSAVPGSFYGRLFPRRSLHFVHSSSSLHWLSQVPCREAEKEDRTITADLENMGKIYISKTSPKSAHKAYALQFQTDFLVFLRSRSEELVPGGRMVLSFLGRRSLDPTTEESCYQWELLAQALMSMAKEGIIEEEKIDAFNAPYYAASSEELKMVIEKEGSFSIDRLEISPIDWEGGSISEESYDLAIRSKPEALASGRRVSNTIRAVVEPMLEPTFGENVMDELFERYAKIVGEYFYVSSPRYAIVILSLVRTG

SEQ ID NO: 4 - DNA, 30 bp, Artificial Sequence
  Description of Artificial Sequence 5′ primer for PCR of JMT gene
cgcgtccgaattcgagagagagagaatgga

SEQ ID NO: 5 - DNA, 30 bp, Artificial Sequence
  Description of Artificial Sequence 3′ primer for PCR of JMT gene
tttgaagaattcacgactaatgcgtctaca

SEQ ID NO: 6 - protein, 359 aa, Clarkia breweri
MDVRQVLHMKGGAGENSYAMNSFIQRQVISITKPITEAAITALYSGDTVTTRLAIADLGCSSGPNALFAVTELIKTVEELRKKMGRENSPEYQIFLNDLPGNDFNAIFRSLPIENDVDGVCFINGVPGSFYGRLFPRNTLHFIHSSYSLMWLSQVPIGIESNKGNIYMANTCPQSVLNAYYKQFQEDHALFLRCRAQEVVPGGRMVLTILGRRSEDRASTECCLIWQLLAMALNQMVSEGLIEEEKMDKFNIPQYTPSPTEVEAEILKEGSFLIDHIEASEIYWSSCTKDGDGGGSVEEEGYNVARCMRAVAEPLLLDHFGEAIIEDVFHRYKLLIIERMSKEKTKFINVIVSLIRKSD

SEQ ID NO: 7 - DNA, 48 bp, Artificial Sequence
  Description of Artificial Sequence Synthetic nucleotide sequence
ctggttccgcgtggatccccgggaattcgacaaagagagagagagatg

SEQ ID NO: 8 - protein, 16 aa, Artificial Sequence
  Description of Artificial Sequence Synthetic peptide
LVPRGSPGIRQREREM

(19) United States
(12) Patent Application Publication
(10) Pub. No.: US 2003/0064895 A1
(43) Pub. Date: Apr. 3, 2003

(54) Genes for s-adenosyl l-methionine: jasmonic acid carboxyl methyltransferase and a method for the development of pathogen-and stress-resistant plants using the genes

(76) Inventors: Yang-Do Choi, Seoul (KR); Jong-Joo Cheong, Gyeonggi-do (KR); Jong-Seob Lee, Seoul (KR); Jong-Tae Song, Gyeonggi-do (KR); Sang-Ik Song, Gyeonggi-do (KR); Hak-Soo Seo, Gyeonggi-do (KR); Yeon-Jong Koo, Gyeonggi-do (KR)

Correspondence Address: Stephen A Bent, Foley & Lardner, Washington Harbour, 3000 K Street N W Suite 500, Washington, DC, 20007-5143, US

(21) Appl. No.: 10/049,187

(22) PCT Filed: Jun. 5, 2001
(86) PCT No.: PCT/KR01/00953

(30) Foreign Application Priority Data
Jun. 13, 2000 (KR) 2000-32365

(51) Int. Cl. A01N 57/18

(52) U.S. Cl. 504/206

(57) ABSTRACT

The present invention relates to a novel gene for S-adenosyl-L-methionine:jasmonic acid carboxyl methyltransferase, a novel jasmonic acid carboxyl methyltransferase protein synthesized therefrom, and a novel transgenic plant transformed with an expression vector containing said gene. It has been known that said enzyme synthesizes jasmonic acid methyl ester using jasmonic acid and S-adenosyl methionine as the substrate and jasmonic acid methyl ester is a compound mediating the defensive reactions upon invasion of phytopathogenic organisms and harmful insects as well as a compound for regulating the plant growth. By introducing said novel enzyme which is specifically expressed in flowers into the plant body, a transgenic plant which exhibits a resistance against phytopathogens, harmful insects and stresses without causing any adverse effect on the plant growth can be obtained.

### TECHNICAL FIELD

The present invention relates to a novel gene for jasmonic acid carboxyl methyltransferase (S-adenosyl-L-methionine: jasmonic acid carboxyl methyltransferase) and a novel jasmonic acid carboxyl methyltransferase protein synthesized therefrom, and more particularly, to a phytopathogen-, harmful insects and stress-resistant plant transformed with an expression vector containing the gene.

### BACKGROUND ART

It has been known that the jasmonic acid (JA) and the jasmonic acid methyl ester (JAMe) are a family of compounds mediating the defense responses to wound on the plant due to physical damage or harmful insects or invasion of phytopathogenic organisms, as well as a growth regulating material widely present in various kind of plants (Creelman and Mullet, Annu. Rev. Plant Physiol. Plant Mol. Biol. 48:355-381, 1992). In addition, it has also been noted that such resistant reactions are comprised of very complicated signal transmitting network (Glazebrook, Curr. Opin. Plant Biol. 2:280-286, 1999).

When the plant is infected with phytopathogenic organisms such as viruses, bacteria and fungi, the pathways which recognize and react against such infection in plants can be generally classified into the following two pathways: one is the pathway mediated by salicylic acid (SA) and the other is the pathway mediated by JA. It has been known that these pathways involve a chain reaction of many kinds of genes and proteins. Although it has been known that the reaction pathway resistant to the wound by harmful insects is generally mediated by JA, the reaction pathway resistant to virus is generally mediated by SA, and the reaction pathway resistant to bacteria and fungi is generally mediated by SA or JA specifically depending on the kinds of phytopathogens; however, this classification is not absolute (Reymond and Farmer, Curr. Opin. Plant Biol. 1: 404-411, 1998). Such reactions can allow the plants to withstand stimulations caused by phytopathogens and harmful insects through a systemic response diffused throughout the whole plant body, as well as a local response rapidly occurred in the damaged and infectious region (Durner et al., Trends Plant Sci. 2:266-274, 1997).

In such a reaction, SA stimulates a series of genes, such as PR-1 (pathogenesis related protein-1), PR-2 and PR-5, to induce the expression of corresponding proteins, thereby allowing to occur a systemically acquired resistance throughout the whole plant body (Uknes et al., Plant Cell 4:645-646, 1992), and JA stimulates a series of genes, such as PDF1.2 (plant defensin), PR-3 and VSP (vegetative storage protein), to induce the expression of corresponding proteins (Penninckx et al., Plant Cell 8:2309-2323, 1996). Recently, it has been reported that some symbiotic fungi build an induced systemic resistance reaction through JA synthesis (Pieterse et al., Plant Cell 10:1571-1580, 1998). JA transmits a signal from the region damaged by harmful insects or physical causes, and as a result, allows the plant to build a resistance to the damage in the whole body as well as the infected region. However, among genes induced in said reactions, some genes such as Pin2 (proteinase inhibitor II) may be induced by both SA and JA, and therefore, such classification of the resistant reactions is not specifically absolute. Thus, it has been accepted that any correlation between signal transmission pathways mediating the two reactions may be present (Reymond and Farmer, Curr. Opin. Plant Biol. 1:404-411, 1998).

In the prior art, as an effort in the molecular breeding field to obtain the plant resistant to phytopathogens and harmful insects through introduction and expression of recombinant genes, it has been attempted to use one or two genes, which are determined to be induced by SA and JA and then to be involved in the resistant reactions, such as Pin2, PR3 or PR5. As a result, although plants may acquire some resistance to phytopathogens and harmful insects, this acquired resistance is applicable to a limited number of pathogens and insects (Zhu et al., Bio/Technology 12:807-812, 1994). Meanwhile, it has been reported that when Arabidopsis species are transformed with NPR1 (non-expresser of PR1) gene, which is recognized as one of the important regulators in SA signal transmission pathway, they become somewhat resistant to Peronospora parasitica and Pseudomonas syringae (Cao et al., Proc. Natl. Acad. Sci. 95:6531-6536, 1998).

In order to clearly identify the role of SA and JA mediating such resistant reactions, the study has been made to quantitatively analyze a change of the concentration of these materials in the plants damaged by phytopathogens and harmful insects or to determine the response of plants in the expression level of resistant genes after externally spreading SA or JA. However, since solubility and volatility of JA are very low, the study has been made using JAMe, which is believed to convert into JA after being penetrated into the plant (Farmer and Ryan, Proc. Natl. Acad. Sci. 87:7713-7716, 1990). Furthermore, the distribution patterns of JA and JAMe in plant tissues do not differ much from each other so that these two materials cannot be distinguished from each other (Creelman and Mullet, Annu, Rev. Plant Physiol. Plant Mol. Biol. 48:355-381, 1992). Moreover, in the prior art, since JMT enzymes capable of synthesizing JAMe from JA have not been identified, any study relating to the metabolism and function of this material has never been made. However, it has been reported that JAMe, which is more volatile, can move through air to induce the disease-resistant reaction of other plants (Farmer and Ryan, Proc. Natl. Acad. Sci. 87:7713-7716, 1990). Therefore, a possibility that JAMe will be a stronger disease-resistant inducing material, which functions at a low concentration, cannot be excluded.

Thus, by paying attention to the relationship between the concentration of SA and JA in the plant body and a disease-resistant reaction, the study of a mutant having an increased SA concentration in the body such as Isd6 (lesions simulating disease 6), Isd7, acd2 (accelerated cell death 2), has been conducted. However, although the mutant having a consistently increased SA concentration in the body could increase the expression levels of disease-resistant genes and show a resistance to various disease, it has also been found that such mutant is unsuitable for applying to the economical crops since the height of the mutant becomes dwarfish and the early ageing phenomenon has appeared (Greenberg et al., Cell 77:551-563, 1994; Weymann et al., Plant Cell 7:2013-2022, 1995).

However, the mutant having consistently increased JAMe concentration in the body has not been known yet, and therefore, the study to increase the resistance to the damage caused by phytopathogens and harmful insects by introducing and expressing the genes, such as LOX II (lipoxygenase II) or AOS (alien oxide synthase) genes, which are concerned to the previous step of the JA biosynthesis in the plant body, has been conducted. It has been noted that when AOS gene is over-expressed in chloroplast, JA concentration in the plant body was increased by 6-12 times, whereas the expression of disease-resistant genes such as Pin2 was not increased; moreover, the disease-resistance was not demonstrated (Harns et al., Plant Cell 7:1645-1654, 1995). Furthermore, when AOS gene is over-expressed in cytoplasm, JA concentration in the plant body did not change, and reaction pattern of this plant against the damage was not distinguished from that of the corresponding wild type plant (Wang et al., Plant Mol. Biol. 40:783-793, 1999). It has been known that contrary to SA, JA greatly affects to development, differentiation and metabolism of the plant in a various manner. Therefore, it has been regarded that the over-expression of JA is also involved in various reactions as well as the disease-resistance of the plant, and therefore, JA will have a great possibility of exerting the undesirable effect on the development, differentiation and metabolism of plant, as with SA.

Thus, the present inventors have extensively studied the effect of JAMe on plants and, as one of the result thereof, have identified and characterized a novel jasmonic acid carboxyl methyltransferase protein and a novel gene encoding said methyltransferase. In addition, the present inventors also found that the transgenic plants transformed with said gene enhance the expression of numerous genes relating to a plant resistance against the damage caused by phytopathogens and harmful insects through the production of JAMe, and consequently, have a resistance against plant damages caused by various phytopathogens, harmful insects and further stresses, with substantially no side effect-thus, completed the present invention.

### DISCLOSURE OF INVENTION

The object of the present invention is to provide a novel jasmonic acid carboxyl methyltransferase gene synthesizing JAMe involved in the resistance against the plant damage caused by phytopathogens and harmful insects, and an enzyme protein for which said gene encodes.

Further, another object of the present invention is to provide a transgenic plant with an increased resistance against damages caused by various phytopathogens and harmful insects and a minimum side-effect on plant growth by identifying the characteristics of said enzyme protein, recombining said gene to produce said transgenic plant and then, over expressing said gene, and to provide a method for producing thereof.

In order to attain said objects, the present invention provides a novel jasmonic acid carboxyl methyltransferase, more particularly JMT enzyme having an amino acid sequence of Sequence ID No. 3 isolated from Arabidopsis.

In addition, the present invention provides a cDNA gene represented by Sequence ID. No. 1 encoding said jasmonic acid carboxyl methyltransferase protein.

Furthermore, the present invention provides a recombinant vector constructed by introducing said gene into an expression vector for plant transformation; a method for producing a transgenic plant which over-expresses a gene for jasmonic acid carboxyl methyltransferase in the whole plant body by using said recombinant vector; and a method for enhancing a plant resistance against stress and damages caused by phytopathogene and harmful insects using said transgenic plant.

### BRIEF DESCRIPTION OF THE DRAWINGS

The above objects and other advantages of the present invention will become more apparent by describing in detail of preferred embodiment thereof with references to attached drawings, in which:

FIG. 1 shows the structure of cDNA clone pJMT of jasmonic acid carboxyl methyltransferase (JMT) cloned from Arabidopsis thaliana, wherein a gene for JMT enzyme according to the present invention is inserted into pBlueScript.

FIG. 2 shows the amino acid sequence of protein derived from cDNA gene of JMT enzyme cloned from Arabidopsis thaliana in comparison to the amino acid sequence of protein derived from SAMT as a gene for known salicylic acid methyltransferase (Accession No. AF133053; Ross et al., 1999). In FIG. 2, AtJMT denotes JMT enzyme of Arabidopsis thaliana and SAMT denotes salicylic acid methyltransferase of Clarkia breweri.

FIG. 3 shows the structure of recombinant gene pGST-JMT for expression of JMT gene in the form of a fusion protein with gluthatione S-transferase by inserting JMT gene into pGEX-2T as E. coli expression vector. In FIG. 3, Ptac denotes tac promoter and the underline indicates the nucleotide and amino acid sequences of amino terminal of JMT constituting the fusion protein.

FIG. 4 shows the purity of fusion protein as measured by expressing recombinant gene pGST-JMT in E. coli BL21 in a large quantity, separating the fusion enzyme protein in a purified state and then analyzing the purity of fusion protein by means of SDS-electrophoresis. In FIG. 4, lane 1 is a marker for protein molecular weight; lane 2 is 15 μg of a total protein of E. coli BL21/pGEX-2T; lane 3 is 15 μg of a total protein of E. coli BL21 transformed with pGST-JMT vector containing JMT gene according to the present invention; lane 4 is 5 μg of the eluate from gluthatione agarose column; and lane 5 is 5 μg of the eluate from Superdex 200 column.

FIG. 5 shows the result obtained by reacting recombinant enzyme protein GST-JMT as separated in a purified state with jasmonic acid (JA) and S-adenosyl methionine (SAM) as the substrate and then identifying the synthesis of jasmonic acid methyl ester (JAMe) by means of gas chromatography and mass spectrometry. In FIG. 5, A is the analysis result of JAMe and B is the analysis result of enzyme reaction product.

FIG. 6 is a graph showing that the fusion enzyme protein GST-JMT uses JA and [¹⁴C]SAM as the substrate to specifically stimulate the methylation reaction, as identified by examining a specificity of the reactions of fusion enzyme protein GST-JMT separated above with various compounds. In FIG. 6, Con denotes the result of enzyme reaction only with [¹⁴C]SAM without JA as the substrate; SA denotes the result of enzyme reaction with salicylic acid and [¹⁴C]SAM as the substrate; JA denotes the result of enzyme reaction with JA and [¹⁴C] SAM as the substrate; and BA denotes the result of enzyme reaction with benzoic acid and [¹⁴C]SAM as the substrate.

FIG. 7 is a graph showing the result obtained by examining [¹⁴C]JAMe production activity using crude protein extract obtained from leaves of transgenic and wild type Arabidopsis thaliana. In FIG. 7, indicates the crude protein extract from transgenic plant and indicates the crude protein extract from wild-type plant.

FIG. 8 shows the structure of recombinant pCaJMT gene constructed by inserting JMT gene into expression vector pBI121 for plant transformation, wherein CaMV denotes cauliflower mosaic virus (CaMV) 35S promoter.

FIG. 9 is the result obtained from genomic Southern blot analysis for determining whether JMT gene is correctly inserted into transgenic Arabidopsis thaliana. In FIG. 9, lane W is a wild-type Arabidopsis thaliana, lane T is a transgenic Arabidopsis thaliana, CaMV is the result using CaMV35S promoter sequence as the probe, and AtJMT is the result using JMT gene sequence as the probe.

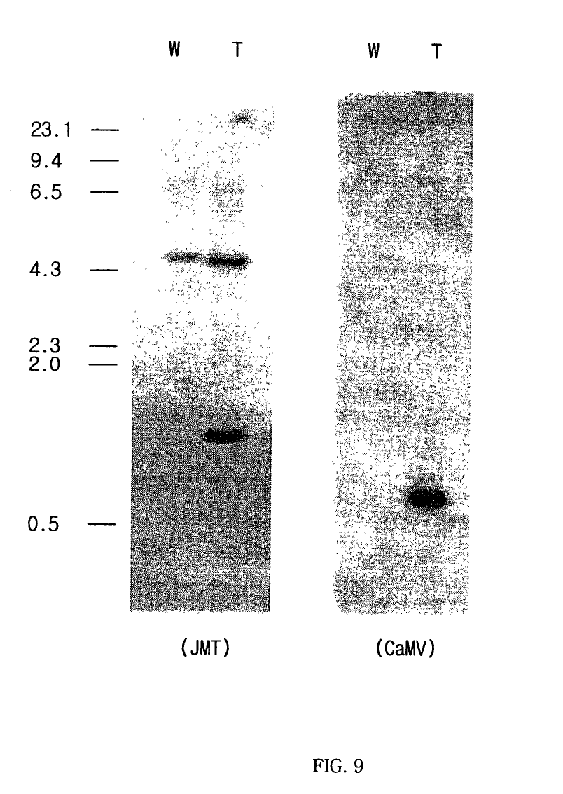

FIG. 10 is the result obtained from Northern blot analysis for identifying whether transgenic Arabidopsis thaliana over-expresses JMT gene (1, 2, 3) and expresses plant resistance-related genes induced by jasmonic acid. In FIG. 10, lane W is a wild-type Arabidopsis thaliana, lane T is a transgenic Arabidopsis thaliana, AOS indicates the probe gene for allene oxide synthase, DAHP for 3-deoxy-D-arabino-heptulosonate 7-phosphate synthase, JR2 for jasmonate response protein 2, JR3 for putative aminohydrolase, LOXII for lipoxygenase II and VSP for vegetative storage protein, etc.

FIG. 11 is a photograph showing the result obtained by inoculating Botrytis cinerea as the causative organism of gray mold rot on transgenic and wild-type Arabidopsis thaliana, and then examining a resistance of plants against fungal disease, wherein the left one shows the result of wild-type Arabidopsis thaliana and the right one shows the result of transgenic Arabidopsis thaliana.

### BEST MODE FOR CARRYING OUT THE INVENTION

Hereinafter, the present invention will be more specifically explained.

In the present invention, the term “jasmonic acid carboxyl methyltransferase” is used as the generic term referring to an enzyme having an activity to synthesize JAMe by transferring methyl group to JA. In addition, the term “JMT enzyme” refers to a novel enzyme protein originated from Arabidopsis, which is first identified in the present invention, as one of said “jasmonic acid carboxyl methyltransferase”. A gene encoding said enzyme protein is designated as “JMT gene” herein.

In the present invention, a novel JMT enzyme gene was isolated from Arabidposis and was confirmed from determination of its base sequence that it has 1,170 bp nucleotide sequence encoding 389 amino acids. First, c38 clone specifically expressed in nectary was screened from cDNA library prepared from flower of Chinese cabbage by means of a hybridization method. This gene has only a length of 416 bp. Therefore, it was found that it is a partial clone of gene specifically expressed in nectary but the function thereof could not be identified. Thus, a clone similar to c38 was screened from cDNA library of Arabidopsis using said c38 clone as probe. This clone has a full length of 1,476 bp, contains successive 13 adenosines at 3′-terminal and a translation start codon AUG at the 15^{th} base pair point from 5′-terminal, and encodes successively 389 amino acids over 1,167 bp. In view of such structural characteristics, it could be noted that this selected cDNA clone is a full-length cDNA clone. This clone was revealed as jasmonic acid carboxyl methyltransferase gene as a result of functional analysis according to the method described hereinafter, and was named pJMT. This clone pJMT was deposited with the Korean Collection for Type Cultures on May 29, 2000 under accession number KCTC 0794BP.

JMT enzyme encoded by said gene has 389 amino acids represented by Sequence ID No. 3 and a molecular weight of 43,369 Da.

To examine the activity of said enzyme, NCBI gene database was searched. As a result, JMT gene has no similarity to the gene for SAMT (salicylic acid methyltransferase) at a base level whereas JMT enzyme protein shows 43% homology with SAMT enzyme at an amino acid level. However, according to the result of gas chromatography and mass spectrometry after reaction of SA, JA or similar benzoic acid (BA) and SAM using recombinant enzyme protein, it could be identified that JMT enzyme does substantially not react with SA and BA but shows a high reactivity with JA, and therefore, is an enzyme having different activity from SAMT. In addition, according to the result of gas chromatography after reaction of said recombinant enzyme protein with JA and SAM as the substrate, the resulting material was detected after the same retention time (11.7 minutes) as the standard JAMe and also has the molecular weight of 224 identical to that of the standard JAMe. Therefore, it could be identified that this JMT enzyme is jasmonic acid carboxyl methyltransferase which synthesize JAMe as one of major flavoring ingredients of flowers by using SAM of formula 1 and JA of formula 2 as the substrates to transfer methyl group to JA:

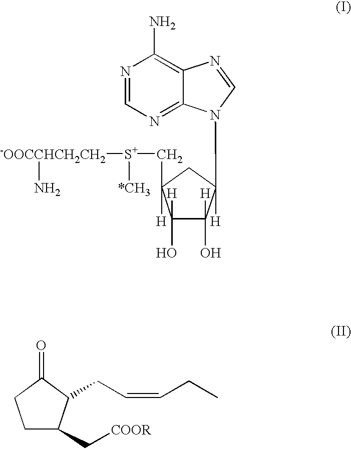

The activity and gene of such jasmonic acid carboxyl methyltransferase were never been disclosed heretofore.

In the present invention, the kinetic parameters of enzyme were investigated in order to identify the characteristic features of said novel JMT enzyme. As a result, it was determined that Kₘ is 6.3 μM, Vₘ is 84 nmole/min., K_{cat} is 70 s⁻¹, and K_{cat}/Kₘ, is 11.1 μM/s⁻¹.

In the present invention, in order to obtain JMT enzyme in a large quantity JMT enzyme was amplified by polymerase chain reaction using oligonucleotides represented by Sequence ID Nos. 4 and 5 as a primer and cDNA clone as a template. The amplified gene was cleaved with restriction enzyme EcoRI and then inserted into pGEX-2T as E. coli expression vector treated with the same restriction enzyme. The resulting recombinant plasmid pGST-JMT was transformed into E. coli BL21, and then resulting transformed strain was incubated to produce the recombinant protein in a large quantity, which was utilized in the subsequent experiment.

Further, the present invention provides a transgenic plant transformed with an expression vector containing jasmonic acid carboxyl methyltransferase gene. The transgenic plant transformed with an expression vector containing jasmonic acid carboxyl methyltransferase gene according to the present invention consistently overexpresses a gene for jasmonic acid carboxyl methyltransferase throughout the whole plant body to exhibit a strong resistance against damages caused by various phytopathogens including viruses, bacteria and fungi, or insects and further against various stresses.

In general, it has been known that JA and JAMe are the compounds mediating the defensive reactions against wound or phytopathogenic invasion in plants. The plant transformed with a gene for jasmonic acid carboxyl methyltransferase according to the present invention consistently expresses the resistance-related genes induced by treatment with JA or JAMe, for example, numerous genes including AOS, JR2 (jasmonate response protein 2), JR3 (putative aminohydrolase), DAHP (3-deoxy-D-arabinoheptulosonate 7-phosphate synthase), LOXII, VSP, etc. Therefore, it can be noted that the effect of plant transformed with a gene for jasmonic acid carboxyl methyltransferase is similar to that obtained from external treatment with JA or JAMe.

By transforming the plant with an expression vector containing jasmonic acid carboxyl methyltransferase gene, the plant body can have a resistance against damages caused by phytopathogens and harmful insects including general fungal diseases, bacterial diseases, viral diseases or damages due to harmful insects, inter alia, blast, bacterial leaf blight, false smut and leafhopper in rice plant; scab in barley; brown spot in maize; mosaic disease in bean plant; mosaic disease in potato; late blight and anthracnose in red pepper; soft rot, root-knot disease and cabbage butterfly in Chinese cabbage and radish; bacterial blight in sesame; gray mold rot and wilt disease in strawberry; Fusarium wilt in watermelon; bacterial wilt in tomato; powdery mildew and downy mildew in cucumber; tobacco mosaic in tobacco; Fusarium wilt in tomato; root rot in ginseng; angular leaf spot in cotton plant; anthracnose and gray mold rot in fruit trees including apples, pears, peaches, kiwi fruit, grape and citrus; canker in apple; witches' broom in jujube tree; powdery mildew and rust in forage crops including ryegrass, red clover, orchard grass, alfalfa, etc.; gray mold rot and wilt disease in flowering plants including rose, gerbera, carnation, etc.; black spot in rose; mosaic disease in gladiolus and orchids; stem rot in lily, and the like.

Since the transgenic plant transformed with a gene for jasmonic acid carboxyl methyltransferase does not occur adverse effect on plant growth which may occur in mutants having a consistent increase of SA concentration in plant body, i.e. problems of dwarfism of plant length and early ageing phenomenon, in applying to economical crops it is more effective than the use of mutants having an increased SA concentration in plant body or transformation with enzyme genes involved in the preceding steps of JA synthesis.

In addition, in view of the fact that JAMe is widely present in various plants, it is considered that JMT gene first cloned according to the present invention will be widely present in various plants. Therefore, JMT gene and enzyme protein according to the present invention can be effectively used in searching similar jasmonic acid carboxyl methyltransferase protein and gene encoding the same from various plants using JMT gene of the present invention according to the known method.

Furthermore, it is considered that the resistance of transgenic plant against damages caused by phytopathogens and harmful insects is derived from the stimulation of expression of numerous resistant genes by JAMe, as a mediator of plant disease-resistant reactions, which is produced by the activity of jasmonic acid carboxyl methyltransferase, rather than from a gene for jasmonic acid carboxyl methyltransferase itself. In view of this, it is determined that as long as the genes encode the proteins having such enzymatic activity, as well as the gene according to the present invention they can also be utilized in producing transgenic plants having an increased resistance and further, provides a similar resistance against various damages caused by pathogens and harmful insects by preparing the recombinant with said genes and then transforming the plant with the recombinant, without any limitation on the kinds of plants.

The method for producing a transgenic plant transformed with said gene for jasmonic acid carboxyl methyltransferase can be practiced according to the known method. Specifically, the recombinant plasmid expressing a gene for jasmonic acid carboxyl methyltransferase can be constructed using the known vector for plant expression as the basic vector. For this purpose, conventional binary vector, co-integration vector or a common vector designed so as be expressed in plant but not containing T-DNA portion can be used.

Among them, as the binary vector is a vector containing left border and right border in a size of about 250 bp, which are involved in the infection of foreign gene, in T-DNA for transformation of plant, and a promoter portion and polyadenylation signal portion for expression in the plant body therein can be used. Preferably, said binary vector additionally contains a selection marker gene such as kanamycin-resistant gene. As the marker gene for selection of transgenic plant herbicide-resistant genes, metabolism-related genes, luminescence genes (luciferase), genes related to physical properties, GUS (β-glucuronidase) or GLA (β-galactosidase) genes, etc. can also be used in addition to antibiotic-resistant genes as mentioned above.

According the preferred embodiment of the present invention, a vector for plant transformation pCaJMT is constructed and used by inserting JMT gene into SmaI site of pBI121 vector having kanamycin-resistant selection gene and cauliflower mosaic virus (CaMV) 35S promoter.

In case of using binary vector or co-integration vector, Agrobacterium strains (Agrobacterium-mediated transformation) can be used as the microorganism strain for plant transformation into which said recombinant vector is introduced, and include, for example, Agrobacterium tumefaciens or Agrobacterium rhizogenes.

Alternatively, when vectors not containing T-DNA portion are used, electroporation, microparticle bombardment, polyethylene glycol-mediated uptake, etc. can be used in introducing the recombinant plasmid into plants.

In one embodiment of the present invention, recombinant plasmid pCaJMT wherein JMT gene was inserted into SmaI site of pBI121 vector having kanamycin-resistant selection gene and CaMV35S promoter was transformed into Agrobacterium C58C1 according to floral dip transformation. Thereafter, the flower stalk was immersed in said culture solution for transformation, placed overnight in the shade and then incubated. The seeds were collected therefrom and screened to select the resistant transformants, which were then transplanted to a soil, thereby obtaining the second-generation seeds. The obtained seeds were again screened to select the second-generation seeds, which do not produce kanamycin sensitive individuals, which were used in the experiment.

First, in order to identify whether the foreign recombinant gene is correctly inserted, the genomic Southern blot analysis was conducted using JMT gene as the probe. As the result thereof, one gene having a length of about 6.5 kbp, which is originally present in Arabidopsis was identified in the wild type plant whereas two DNA sections having length of about 2.0 kbp and 0.7 kbp were further observed in the transformants. It could be seen that these DNA sections are originated from JMT gene used for transformation (HindIII sites are present on the upstream of promoter and the downstream of protein-coding site). They were again hybridized with CaMV35S promoter site present only in recombinant gene as the probe. As a result, it could be identified that only the transformant contains the gene sequence having a length of about 2.0 kbp as expected, and thus, one recombinant gene was stably inserted into the transformant.

Further, whether transgenic Arabidopsis overexpresses JMT gene or not was identified by means of Northern blot analysis. As a result, it was identified that only the transformant expresses JMT gene and particularly, consistently expresses numerous genes including resistance-related AOS, JR2, LOXII, VSP, etc., which are induced when the plant is externally treated with JA or JAMe. This suggests that the effect induced by the expression of JMT gene transformed into the plant is similar to that induced by the external treatment with JA or JAMe.

According to another embodiment of the present invention, the causative pathogen of gray mold rot was inoculated on said transgenic plant. As a result, it has been confirmed that about 48 hours after spray inoculation the wild-type plant completely died whereas the transformant did substantially not occur any change. However, in case of the pathogens belonging to Phytium genus, it has been reported that the treatment with JA even at the level of 130 μM has no effect on the growth of pathogen (Vijayan et al., Proc. Natl. Acad. Sci. 95:7209-7214, 1998). Therefore, it can be seen that a theory by which JMT gene transformant exhibits a resistance against pathogen is that JAMe produced by JMT enzyme induces the expression of various resistance-related genes, rather than that JAMe synthesized in the plant body directly inhibits the growth of pathogens. Thus, the fact that the transgenic plant transformed with JMT gene occurs a consistent expression of various protection-related genes by JAMe suggests that JMT gene can be utilized in providing a broad spectrum resistance against phytopathogens, harmful insects and stress for the plant body.

In another embodiment of the present invention, said transgenic Arabidopsis transformed with JMT exhibited a consistent resistance when it is treated with bacterial phytopathogens, viruses and harmful insects.

According to further embodiment of the present invention, various plants including rice plant, tobacco, potato, citrus, watermelon, cucumber, etc. was transformed using recombinant JMT gene and then treated with various phytopathogens including causative organisms of blast, tobacco mosaic virus (TMV), late blight of potato, gray mold rot in citrus, Fusarium wilt in watermelon, downy mildew in cucumber, etc., and harmful insects. However, all of transgenic plants transformed with recombinant JMT gene consistently exhibited a resistance.

In another embodiment according to the present invention, said transgenic Arabidopsis transformed with JMT gene was examined for its drought resistance, salt resistance and cold resistance. As a result thereof, it has been found that transgenic plant consistently exhibited a significant resistance in comparison to the non-transformed wild type of plant. Therefore, it can be seen that the transgenic plant transformed with a gene for jasmonic acid carboxyl methyltransferase exhibits a resistance against various stresses including low temperature, water deficiency, high salt concentration, etc. as well as a resistance against various damages caused by phytopathogens and harmful insects.

Further, the plants transformed with JMT gene do not occur a significant difference from the non-transformed wild type of plants in view of their general growth properties.

Hereinafter, the present invention will be described in detail with reference to the examples. It will be apparent to a person skilled in the relevant technical field that the following examples illustrate the teachings of the present invention and are not intended as limiting the scope of the invention.

### EXAMPLE 1

### Cloning of Jasmonic Acid Carboxyl Methyltransferase Gene pJMT in Arabidopsis

The seeds of Arabidopsis thaliana ecotype Col-O to be used in the experiment were cultivated in a greenhouse, and then various tissues were collected, rapidly refrigerated in liquid nitrogen and then stored at −70° C. until they are used.

In order to isolate a gene specifically expressed in flower of the plant, a cDNA library was prepared from flower of Chinese cabbage using plasmid pUC18 (Pharmacia, Sweden) according to the known method (Choi et al., J. Korean Agri. Chem. Soc. 36:315-319, 1993). Then, a total RNA was extracted from respective flowers and leaves according to the method described by Chomczynski et al. (1987) and then poly(A)⁺ RNA was separated using oligo(dT) column chromatography from which the first cDNA probe was synthesized by RT-PCR (reverse transcriptase—polymerase chain reaction). By means of a differential hybridization using [³²P]-labeled cDNA probes prepared from flowers and leaved, respectively, clone c38 which is specifically expressed only in flowers was screened from the cDNA library of Chinese cabbage flowers. However, since this gene has only a length of 416 bp, it was found that it is a partial clone of gene specifically expressed in flowers of Chinese cabbage but the function thereof could not be identified.

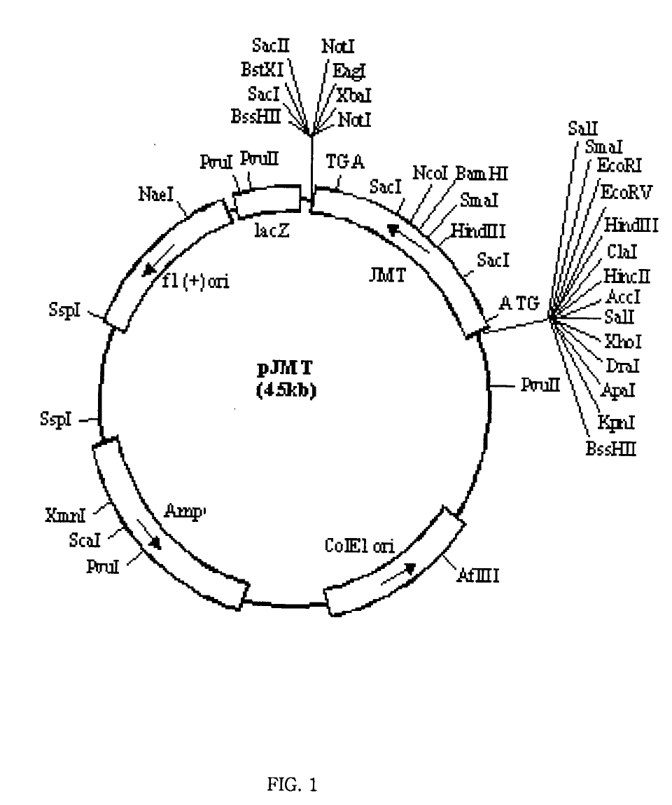

To study the characteristic features of said gene analogous genes were screened in Arabidopsis using c38 clone as the probe. Clone pJMT obtained by screening cDNA library of Arabidopsis has the amino acid sequence represented by Sequence ID No. 2 having a full length of 1,476 bp, and contains successive 13 adenosines at 3′-terminal and a translation start codon AUG at the 15^{th} base pair point from 5′-terminal. Further, it encodes successively 389 amino acids (molecular weight 43,369) represented by Sequence ID No. 3 over 1,167 bp from said translation start codon. In view of such structural characteristics, it could be noted that this selected cDNA clone is a full-length cDNA clone. This clone was revealed as jasmonic acid carboxyl methyltransferase gene as a result of functional analysis according to the method described hereinafter, and was named pJMT of which the structure is depicted in FIG. 1. This clone pJMT was deposited in the Korean Collection for Type Cultures on May 29, 2000 under accession number KCTC 0794BP.

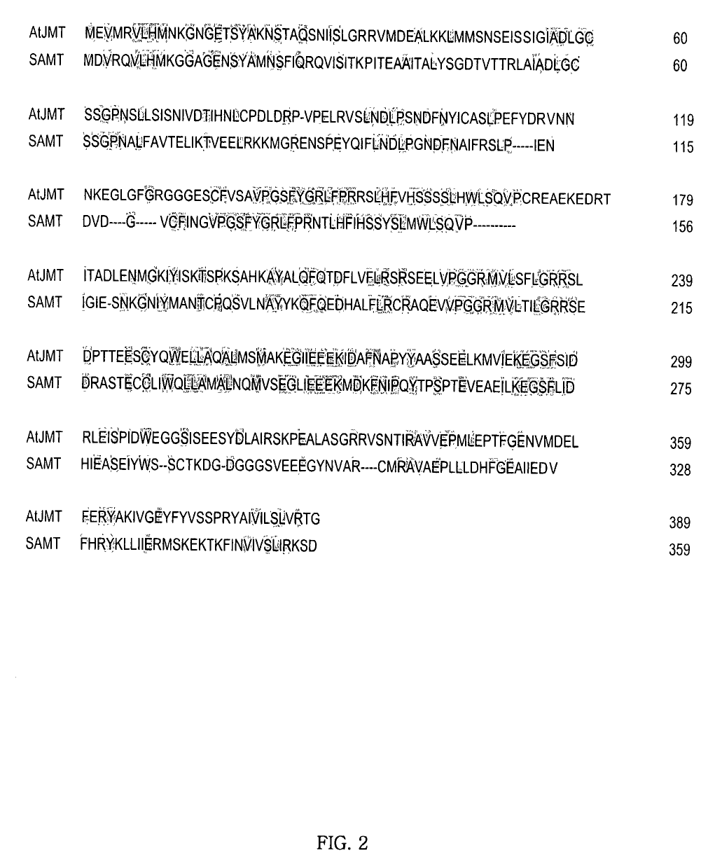

To examine the activity of said enzyme, NCBI (National Center for BioInformation) gene database was searched. As a result, JMT gene has no similarity to the gene for SAMT gene product under Accession number AF133052 (Ross et al., 1999) at a base level but shows 43% homology with SAMT enzyme at an amino acid level (see FIG. 2).

### EXAMPLE 2

### Construction of Recombinant JMT Gene and Large-scale Expression in Escherichia coli

In order to clarify the function of pJMT clone produced in Example 1, the coding site of this clone was recombined with E. coli expression vector to induce a large-scale expression thereof in E. coli. As the primers for amplification of JMT gene, nucleotide sequences represented by Sequence ID No. 4 and Sequence ID No. 5 were used as the primers for PCR reaction in in-sense and anti-sense directions, respectively.

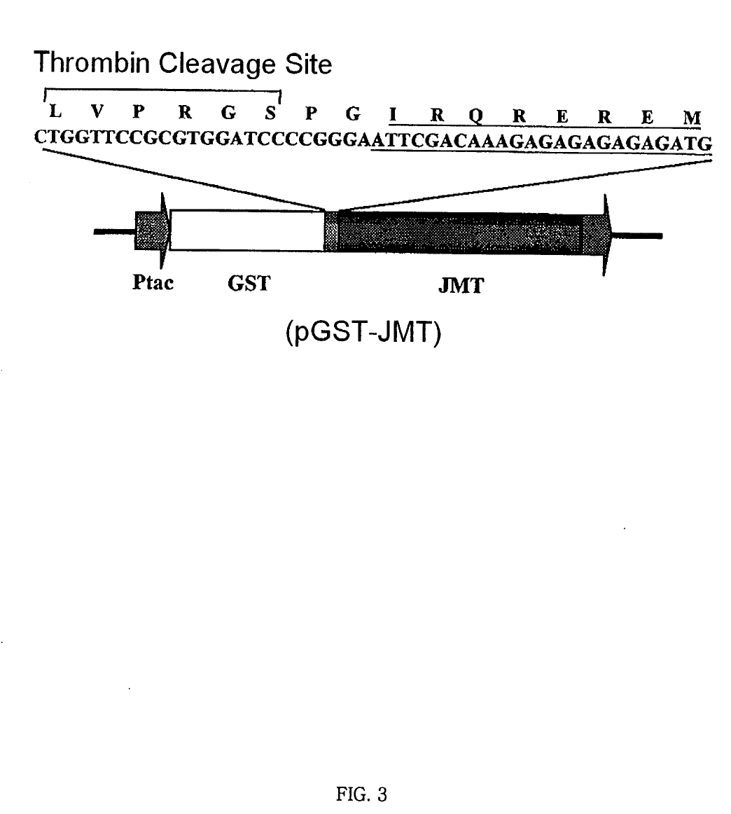

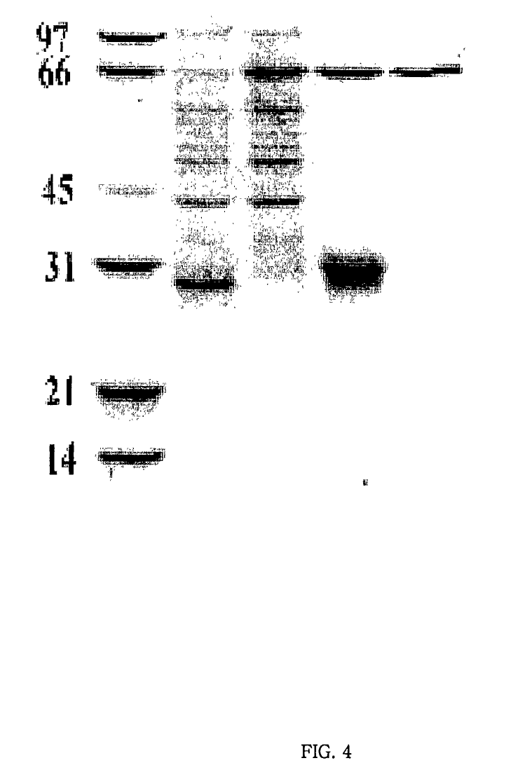

The conditions for PCR reaction are as follows: The gene was placed in a buffer solution containing 10 mM Tris (pH 8.3), 50 mM potassium chloride, 0.8 mM magnesium chloride for 2 minutes at 94° C., and then repeatedly subjected 30 times to a reaction cycle consisting of one minute at 94° C. (denaturation); 1.5 minute at 56° C. (annealing); and 2.5 minute at 72° C. (extension) and further reacted for 10 minutes at 72° C. at the final step (DNA Thermal Cycler 480, Perkin Elmer). The resulting PCR product was electrophoresed on 2% agarose gel, isolated using Geneclean kit (BioRad, USA), and then cleaved with restriction enzyme EcoRI and inserted into E. coli expression vector pGEX-2T (Pharmacia, Sweden), which was previously cleaved with the same restriction enzyme (see FIG. 3). The recombinant expression vector pGST-JMT thus produced produces a fusion protein formed by combining the amino terminal of JMT gene with the carboxyl terminal of GST (glutathione S-transferase) under control of tac promoter. E. coli BL21 was transformed with the recombinant plasmid prepared above, and then incubated and treated with 0.5 mM isopropyl-β-D-thiogalactoside to induce the expression. The recombinant protein was isolated in a purified state by glutathione agarose chromatography and Superdex 200 column chromatography and then analyzed for its purity by SDS-electrophoresis (see FIG. 4). As a result, it could be identified that the recombinant protein GST-JMT having the expected size (molecular weight 67,000) was isolated in a purified state.

### EXAMPLE 3

### Assay for Enzyme Activity of Recombinant JMT Protein

The recombinant enzyme protein as isolated in a purified state by Example 2 was reacted with JA and SAM as the substrate and then subjected to gas chromatography and mass spectroscopy to identify the synthesis of JAMe.

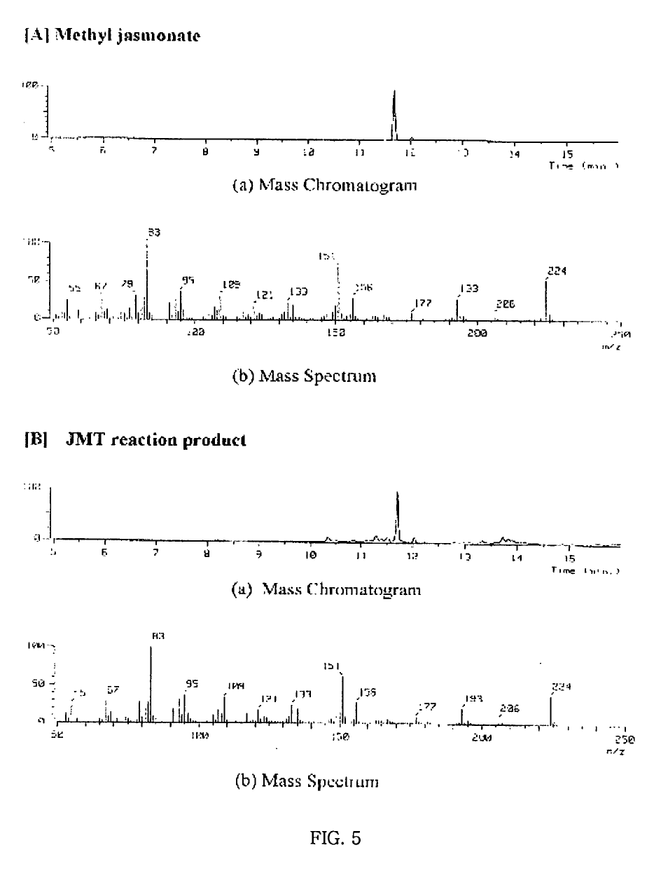

In the test tube, 1 mM JA and 1 mM SAM were introduced in the presence of 100 mM potassium chloride, mixed with 10 pmole of the recombinant enzyme protein isolated in a purified state to make 100 μl of a total volume of the reaction solution, and then reacted together for 30 minutes at 20° C. The reaction product was extracted with ethyl acetate and then 3 μl of the ethyl acetate concentrate was analyzed by gas chromatography. As a result, the reaction product was detected after the same retention time (11.7 minutes) as the standard JAMe and has the molecular weight of 224 as like as the standard JAMe (see FIG. 5). From the above result, it could be confirmed that cDNA clone pJMT is a gene for JMT enzyme.

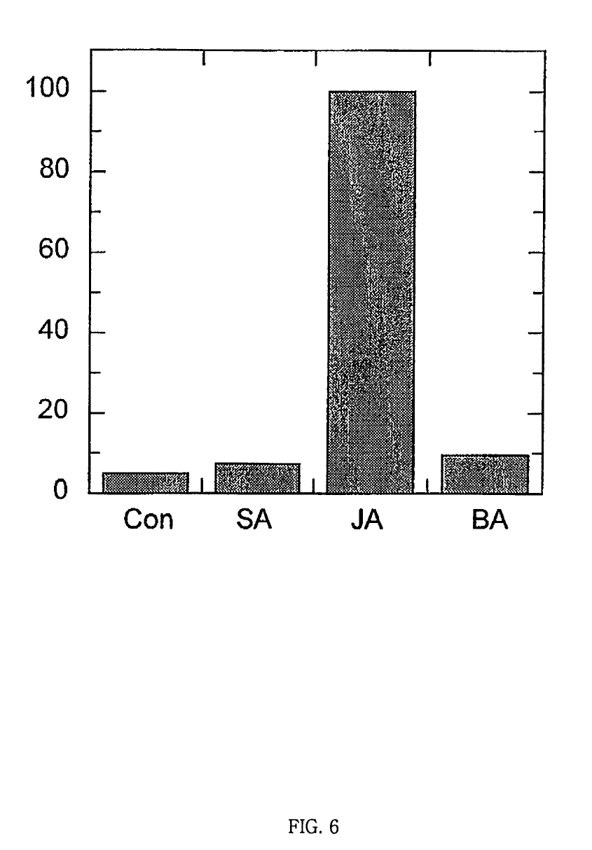

Alternatively, when the activity for the enzyme reaction using JA and [¹⁴C]SAM as the substrate is defined to be 100% as shown in FIG. 6, the reaction using SA or similar benzoic acid (BA) instead of JA as the substrate was substantially not proceeded. Therefore, it could be determined that JMT enzyme protein as isolated in a purified state is specifically reacted with JA.

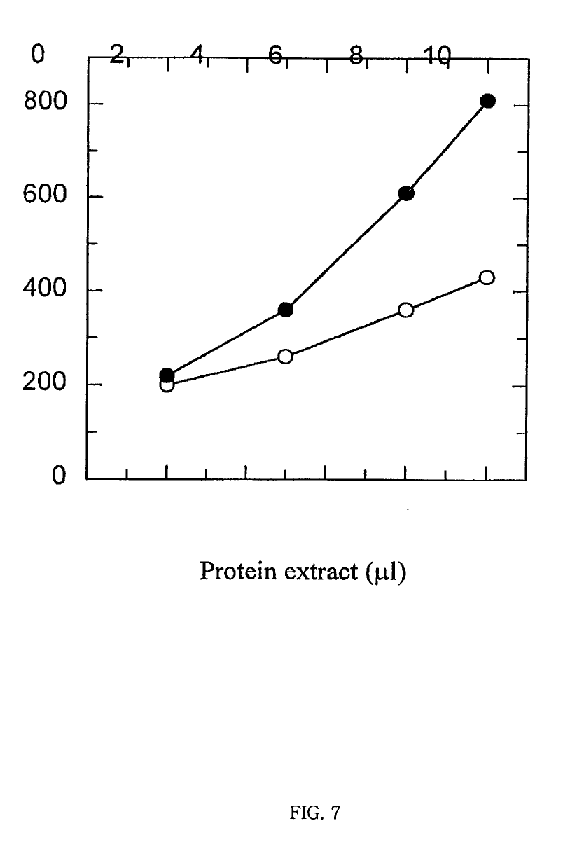

Further, the crude protein extract was reacted with 6.4 mM [¹⁴C]SAM and 1 mM JA as the substrate in the presence of 100 mM potassium chloride for 30 minutes at 20° C. and then analyzed for the [¹⁴C]JAMe production activity. The result thus obtained is depicted in FIG. 7. As can be seen from FIG. 7, the [¹⁴C]JAMe production activity in the crude extract of transgenic Arabidopsis amounts up to 2 times the activity from the wide-type plant.

### EXAMPLE 4

### Enzymatic Characterization of Recombinant JMT Protein

Using SAM and JA as the substrate, the relationship between the substrate concentration and the reaction kinetics was examined. From this, Kₘ, Vₘ, K_{cat} and K_{cat}/Kₘ were obtained by Lineweaver-Burk plot and the result is listed in the following Table 1.

TABLE 1
Kinetic parameter of jasmonic acid carboxyl methyltransferase

| | | | | K_{cat}/ |
|---|---|---|---|---|
| Substrate | Kₘ (μM) | Vₘ (nmole/min) | K_{cat} (s⁻¹) | Kₘ (μM⁻¹s⁻¹) |
| SAM | 6.3 | 84 | 70 | 11.1 |
| (±)JA | 38.5 | 30 | 15 | 0.4 |

### EXAMPLE 5

### Production of Transgenic Plant Using JMT Gene

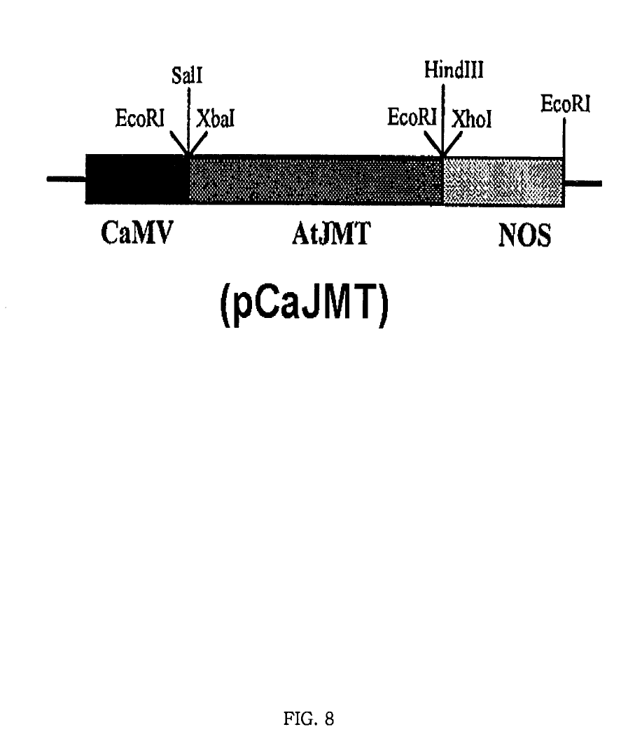

To transplant JMT gene into the plant JMT gene was recombined to a vector for plant transformation. The recombinant plasmid pCaJMT was constructed by deleting GUS gene from pBI121 vector (ClonTech, USA) having kanamycin-resistant selection gene and CaMV35S promoter as the basic promoter and then inserting JMT gene cleaved with AflIII into Smal site of pBI121 vector (see FIG. 8). The obtained recombinant plasmid was introduced into Agrobacterium C58C1 (Koncz and Schell, Mol. Gen. Genet. 204:383-396, 1986) using freeze-thaw method (Holster M. et al., Mol. Gen. Genet. 163:181-187, 1978).

First, Agrobacterium strain was incubated in 5 ml of YEP (yeast extract-peptone) medium for 24 hours at 28° C. and then centrifuged with 5,000 rpm for 5 minutes at 4° C. The bacterial pellets thus obtained were resuspended in 1 ml of 20 mM potassium chloride solution and about 1 μg of vector DNA prepared above was introduced therein. The mixture was treated with liquid nitrogen for 5 minutes and for another 5 minutes at 37° C. and then 1 ml of YEP medium was added thereto. The bacterial strain was incubated for 2-4 hours at 28° C., collected and then incubated in YEP medium containing gentamycin (25 μg/ml) and kanamycin (50 μg/ml) for 2 to 3 days at 28° C. to select only the strain transformed with pCaJMT.

The selected strain was transformed into Arabidopsis. The production of transgenic plant was conducted using the known Agrobacterium-mediated floral dip method (Clough and Bent, Plant J. 16:735-743, 1998). Agrobacterium was incubated overnight in YEP medium containing antibiotics, centrifuged and then suspended in MS medium supplemented with 0.05% Silwet L-77 (Lehle Seeds, USA) to OD₆₀₀=0.8. To this suspension was immersed upside down the flower stalk of Arabidopsis which begins to come out flowers for 15 minutes, which was then allowed to stand in cool shade overnight after removing water. On the next day, the plant was transferred to incubation chamber and then incubated to obtain the seed. The seed was germinated again in kanamycin medium and screened to obtain the tranformant showing kanamycin resistance, which was then transplanted to soil to obtain the second-generation seed. The obtained seeds were again screened in kanamycin medium to select the second-generation seeds, which do not produce kanamycin sensitive individuals, as the pure diploid, which was used in the subsequent experiment.

In order to identify whether the recombinant gene is correctly inserted, the genomic Southern blot analysis was conducted. First, genomic DNAs were isolated from transgenic and wild type plants, cleaved with restriction enzyme HindlII and then electrophoresed on 0.8% agarose gel. The gel was stamped on the filter, which was then hybridized with JMT gene as the probe and sensitized on X-ray film. As a result, one gene having a length of about 6.5 kbp, which was originally present in Arabidopsis was identified in the wild type plant whereas one gene comprising about 2.0 kbp and 0.7 kbp sections were further observed in addition to the original gene in the transformants (HindIII sites are present on the upstream of promoter and the downstream of protein-coding site). The same film was washed, hybridized with CaMV promoter site present only in recombinant gene as the probe and then sensitized on X-ray film. As a result, since only the transformant showed the gene site having a length of about 2.0 kbp, it could be identified that one recombinant gene was stably inserted into the transformant.

### EXAMPLE 6

### Identification of Expression of JMT Gene in Transgenic Plant

In order to identify whether transgenic Arabidopsis over-expresses JMT gene or not, Northern blot analysis was conducted.

First, leaf tissues of transgenic Arabidopsis from which JMT gene was detected was treated with a single-step RNA isolation method (Chomczynski, Analytical Biochemistry 62:156-159, 1987) to isolate a total RNA. Specifically, 2-5 g of Arabidopsis leaf tissues was ground in liquid nitrogen to a fine powder, and then vigorously shaken with 10 ml of TRI-reagent (Sigma, U.S.A.) for 10 seconds and allowed to stand on ice for 15 minutes. Then, 2 ml of chloroform was added and well mixed together. The mixture was allowed to stand for 15 minutes at room temperature and centrifuged at 4° C., 3000 rpm for 20 minutes. The supernatant was collected and 10 ml of isopropyl alcohol was added thereto. The mixture was allowed to precipitate for 10 minutes at room temperature and then again centrifuged with 10,000×g for 20 minutes. After centrifugation, the supernatant was discarded to separate the precipitated RNA, which was then washed with 75% ethanol, dissolved in DEPC-treated distilled water, quantitatively analyzed by measuring the optical density of OD₂₆₀ and OD₂₈₀ and then stored at −70° C. until it is used.

30 μg of a total RNA isolated as above was concentrated to the final volume of 4.5 μl and then was adjusted to a total volume of 20 μl by adding 10× MOPS [0.2 M 3-(N-morpholino)propanesulfonic acid (pH 7.0), 50 mM sodium acetate, 10 mM EDTA (pH 8.0)], formamide and formaldehyde in the ratio of 1:1.8:5. The resulting mixture was heat-treated for 15 minutes at 65° C. to loose the secondary structure, well mixed with 2 μl of formamide gel-loading buffer solution (50% glycerol, 1 mM EDTA (pH 8.), 0.25% bromophenol blue, 0.25% xylene cyanol FF) and then slowly electrophoresed on 1.5% agarose gel containing formaldehyde (2.2 M) in the ratio of 4 V/cm.

The developed RNA was immersed in DEPC-treated water for about one hour to remove formaldehyde and then transferred to nylon membrane (Hybond-N, Amersham) by a capillary transfer method over 16 hours or more and fixed with UV radiation (254 nm, 0.18 J/Sq.cm²) to be used for hybridization. JMT gene was labeled with [α-³²P]dCTP using a random primer labeling kit (Boehringer Manheim) and used as the probe for hybridization. The prehybridization solution (5× SCC, 5× Denhardt's reagent, 0.1% SDS, 100 μg/ml denatured salmon sperm DNA) was added to nylon membrane to which RNA is completely combined, and allowed to stand in an oven for hybridization for 2 hours at 65° C. Then, the labeled probe was denatured for 5 minutes in boiling water, added to prehybridization solution and then allowed to react for 18 hours. On the next day, nylon membrane was rinsed in 2× SCC, 0.1% SDS for 10 minutes at room temperature, rinsed again in 0.2× SCC, 0.1% SDS for 20 minutes and then washed at elevated temperature of 65° C. while measuring the signal with Geiger counter. After washing is completed, nylon membrane was covered with wrap, overlaid with X-ray film and then sensitized at −70° C.

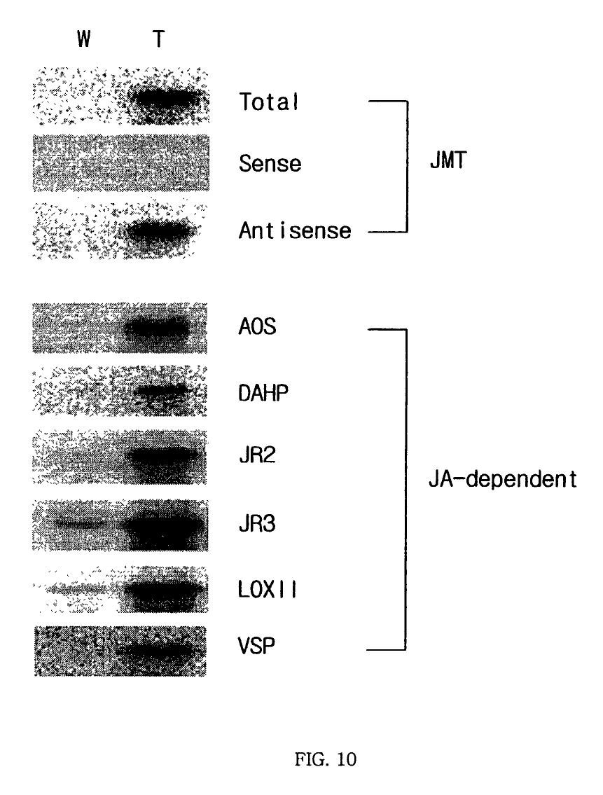

As a result, as can be seen from FIG. 10, it was identified that transgenic Arbidopsis over-expresses JMT gene. As can be seen from genome blot in Example 5, although Arabidopsis naturally contains JMT gene, such gene is specifically expressed only in flowers but not in leaves as indicated by Northern blot analysis. However, the transplanted foreign recombinant JMT gene was uniformly expressed throughout the whole plant body by recombining the gene with CaMV35S promoter.

Further, the expression of genes including AOS, JR2, JR3, DAHP, LOXII, VSP etc., which are induced when the plant is externally treated with JA or JAMe was also examined. As a result, it could be identified that such genes are consistently expressed in the transgenic plants transformed with JMT gene (see FIG. 10). This suggests that the expression effect induced by JMT gene as transplanted into the plant is similar to that induced by the external treatment with JA or JAMe.

### EXAMPLE 7

### Identification of Resistance of Transgenic Plant Against Fungal Diseases

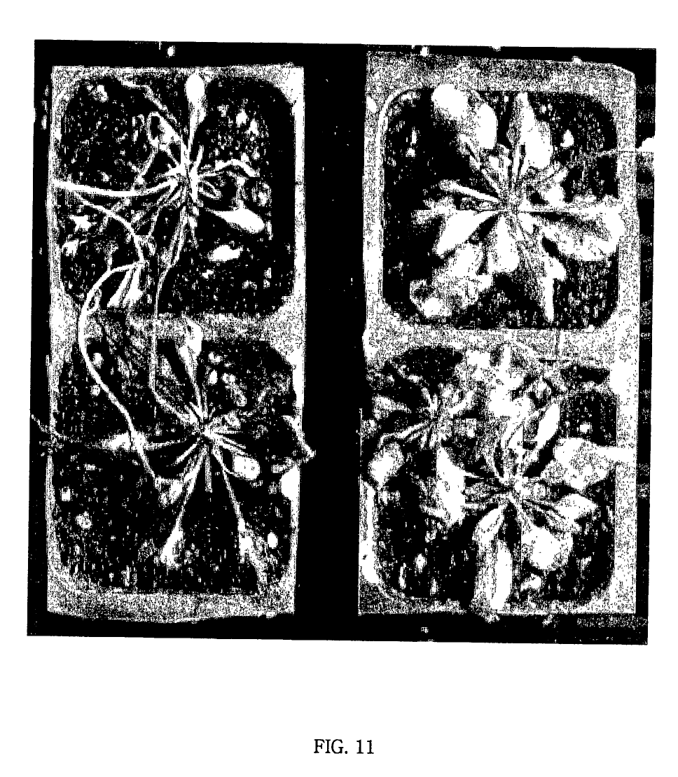

The transgenic Arabidopsis transformed with JMT gene was inoculated with the causative pathogen of gray mold rot (Botrytis cinerea) to investigate the effect of JMT gene on the resistance against fungal pathogens in the plant body. Each of the transgenic and wild type Arabidopsis was cultivated for 7 weeks and then spray-inoculated on their leaves with the spores of pathogenic fungi at the concentration of 10⁷/ml. As a result, it has been confirmed that after about 48 hours the wild-type plant completely died whereas the transgenic plant did substantially not occur any change (see FIG. 11). In case of the pathogens belonging to Phytium genus, it has been reported that the treatment with jasmonic acid even at the level of 130 μM has no effect on the growth of pathogen (Vijayan et al., Proc. Natl. Acad Sci. 95:7209-7214, 1998). This finding suggests that the reason why the transgenic plant transformed with JMT gene exhibits a resistance against pathogen is that the transgenic plant consistently expresses various resistance-related genes as induced by JA and JAMe, rather than that JAMe synthesized in the plant body directly inhibits the growth of pathogens. However, the transgenic plant does not occur a significant difference from the non-transformed wild-type plant in view of their general growth properties.

### EXAMPLE 8

### Investigation of Resistance of Transgenic Plant Against Bacterial Diseases

The transgenic Arabidopsis transformed with JMT gene was inoculated with the causative pathogen of bacterial black spot (Pseudomonas syringae pv tomato CD3000) to investigate the effect of JMT gene on the resistance against bacterial pathogens in the plant body. Each of the transgenic and wild type Arabidopsis was cultivated for 7 weeks and then spray-inoculated on their leaves with cells of Pseudomonas syringae pv tomato CD3000 at the concentration of 10⁷/ml. As a result, it has been confirmed that after 3 days the wild-type plant occurred transparent yellow lesion starting from the edge of leaves whereas the transgenic plant, which consistently expresses JMT gene occurred merely a slight lesion on the edge of leaves (see Table 2). This finding suggests that the transgenic plant transformed with JMT gene has a resistance against bacterial pathogen.

TABLE 2
Resistance of transgenic Arabidopsis transformed with JMT
against bacterial diseases

| | Number of plants | % Area of lesion |
|---|---|---|
| Non-transgenic | 10 | 60 |
| (wild-type) | | |
| Transgenic | 10 | 5 |
| (JMT) | | |

### EXAMPLE 9

### Investigation of Resistance of Transgenic Plant Against Viral Diseases

The transgenic Arabidopsis transformed with JMT gene was inoculated with BCTV (beet curly top virus) to investigate the effect of JMT gene on the resistance against viral diseases in the plant body. Each of transgenic and wild type Arabidopsis was cultivated for 4 weeks and then inoculated on their leaves with Agrobacterium transformed with BCTV clone by means of a syringe. As a result, it has been confirmed that after 4 weeks the wild-type plant began to occur the curling phenomenon on leaves whereas the transgenic plant, which consistently expresses JMT gene did not occur any significant change (see Table 3). This finding suggests that the transgenic plant transformed with JMT gene has a resistance against viral diseases.

TABLE 3
Resistance of transgenic Arabidopsis transformed with JMT
against viral diseases

| | | Number of curled | Curled area of |
|---|---|---|---|
| | Number of plants | leaves | leaves (%) |
| Non-transgenic | 10 | 47 | 60 |
| (wild-type) | | | |
| Trnasgenic | 10 | 4 | 5 |
| (JMT) | | | |

### EXAMPLE 10

### Investigation of Resistance of Transgenic Plant Against Harmful Insects

The transgenic Arabidopsis transformed with JMT gene was inoculated with 20 dark winged fungus gnats in a reticular chamber to investigate the effect of JMT gene on the resistance against harmful insects in the plant body. Each of the transgenic and wild type Arabidopsis was cultivated for 6 weeks and then inoculated in a reticular chamber with 20 dark winged fungi gnats. As a result, it has been confirmed that after 4 weeks insects ate most leaves of the wild-type plant whereas the transgenic plant, which consistently expresses JMT gene did not occur any significant damage (see Table 4). This finding suggests that the transgenic plant transformed with JMT gene has a resistance against harmful insects.

TABLE 4
Resistance of transgenic Arabidopsis transformed with JMT
against harmful insects

| | | Eaten area of leaves | Survival rate |
|---|---|---|---|
| | Number of plants | (%) | (%) |
| Non-transgenic | 10 | 80 | 40 |
| (wild-type) | | | |
| Trnasgenic | 10 | 5 | 100 |
| (JMT) | | | |

### EXAMPLE 11

### Investigation of Resistance of Transgenic Rice Plant Against Blast

The transgenic rice plant transformed with JMT gene was inoculated with the causative organism of blast disease (Magnaporthe grisea) to investigate the effect of JMT gene on the resistance against the pathogens in the plant body. Each of transgenic and wild-type rice plants was cultivated for 10 weeks and then spray-inoculated with the spores of Magnaporthe grisea at the concentration of 10⁶/ml, placed overnight under relative humidity of 100% at 25° C. and then cultivated in a plant incubator. As a result, it has been confirmed that after 5 days the wild-type plant occurred 5-10 brown spots on every leaf and therefore, its lesion area was calculated as about 80% whereas the transgenic plant which consistently expresses JMT gene occurred only less than 2 spots (see Table 5). This finding suggests that the transgenic rice plant transformed with JMT gene has a resistance against blast diseases.

TABLE 5
Resistance of transgenic rice plant transformed with JMT
against blast diseases

| | | Number/ | |
|---|---|---|---|
| | Number of | area of lesions | Average number/area of |
| | plants | (number/%) | lesions (number/%/plant) |
| Non-transgenic | 10 | 579/80 | 57.9/80 |
| (wild-type) | | | |
| Trnasgenic | 10 | 37/5 | 3.7/5 |
| (JMT) | | | |

### EXAMPLE 12

### Investigation of Resistance of Transgenic Tobacco Plant Against Mosaic Disease

The transgenic tobacco plant transformed with JMT gene was inoculated with tobacco mosaic virus (TMV) to investigate the effect of JMT gene on the resistance against viral pathogens in the plant body. Each of the transgenic and wild type tobacco plants was cultivated for 10 weeks and then inoculated on their leaves with TMV together with carborundum. As a result, it has been confirmed that after one week the wild type plant occurred 50-100 brown spots on every leaf whereas the transgenic plant which consistently expresses JMT gene occurred only less than 10 slight spots (see Table 6). This finding suggests that the transgenic tobacco plant transformed with JMT gene has a resistance against viral diseases.

TABLE 6
Resistance of transgenic tobacco plant transformed with JMT
against tobacco mosaic virus

| | Number of | Number of | Average number of lesions |
|---|---|---|---|
| | plants | lesions | per leaf (number/leaf) |
| Non-transgenic | 5 | 387 | 77.4 |
| (wild-type) | | | |
| Trnasgenic | 5 | 61 | 6.1 |
| (JMT) | | | |

### EXAMPLE 13

### Investigation of Resistance of Transgenic Potato Plant Against Phytophthora infestans

The transgenic potato plant transformed with JMT gene was inoculated with the causative organism of late blight (Phytophthora infestans) to investigate the effect of JMT gene on the resistance against fungal pathogens in potato plant. Each of transgenic and wild type potato plants was cultivated for 12 weeks and then spray-inoculated with the spores of Phytophthora ibfestans at the concentration of 10⁷/ml. As a result, it has been confirmed that after one week the wild-type plant occurred 50-100 brown spots on every leaf whereas the transgenic plant which consistently expresses JMT gene occurred only less than 10 spots (see Table 7). This finding suggests that the transgenic plant transformed with JMT gene has a resistance against late blight in potato.

TABLE 7
Resistance of transgenic potato plant transformed with JMT
against late blight

| | | Number/ | |
|---|---|---|---|
| | Number of | area of lesions | Average number/area of |
| | plants | (number/%) | lesions (number/%/plant) |
| Non-transgenic | 10 | 464/70 | 46.4/70 |
| (wild-type) | | | |
| Transgenic | 10 | 58/10 | 5.8/10 |
| (JMT) | | | |

### EXAMPLE 14

### Investigation of Resistance of Transgenic Citrus Plant Against Gray Mold Rot

The transgenic citrus plant transformed with JMT gene was inoculated with the causative organism of gray mold rot (Botrytis cinerea) to investigate the effect of JMT gene on the resistance against fungal pathogens in citrus plant. Each fruit of transgenic and wild type citrus plants was spray-inoculated with the spores of Botrytis cinerea at the concentration of 10⁷/ml. As a result, it has been confirmed that after one week the fruit surface of the wild-type plant was substantially covered with gray mold whereas the fruit of the transgenic plant which consistently expresses JMT gene occurred infrequently one or two small fungal colonies on its surface (see Table 8). This finding suggests that the transgenic citrus plant transformed with JMT gene has a resistance against the causative organism of gray mold rot.

TABLE 8
Resistance of transgenic citrus plant transformed with JMT
against gray mold rot

| | Number of | Number of | Average number/area of |
|---|---|---|---|
| | inoculated fruits | lesions | lesions (number/%/fruit) |
| Non-transgenic | 10 | 87 | 8.7/10 |
| (wild-type) | | | |
| Trnasgenic | 10 | 34 | 3.4/10 |
| (JMT) | | | |

### EXAMPLE 15

### Investigation of Resistance of Transgenic Watermelon Against Fusarium Wilt

The transgenic watermelon transformed with JMT gene was inoculated with the causative organism of Fusarium wilt (Fusarium oxysporum) to investigate the effect of JMT gene on the resistance against the causative pathogen of Fusarium wilt in the plant body. The spores of Fusarium oxysporum were suspended at the concentration of 10⁷/ml and mixed with a soil, and then the seedlings of watermelon plant were transplanted to the soil. As a result, it has been observed that after 3 weeks the wild-type plant happened the splitting of stem and the decay of root whereas the transgenic plant that consistently expresses JMT gene occurred few lesions but appeared to be relatively normal (see Table 9). This finding suggests that the transgenic plant transformed with JMT gene has a resistance against Fusarium wilt in watermelon.

TABLE 9
Resistance of transgenic watermelon transformed with JMT
against Fusarium wilt

| | Number of inoculated | Number of infected | Lethality |
|---|---|---|---|
| | plants | plants | (%) |
| Non-transgenic | 10 | 8 | 70 |
| (wild-type) | | | |
| Trnasgenic | 10 | 1 | 10 |
| (JMT) | | | |

### EXAMPLE 16

### Investigation of Resistance of Transgenic Cucumber Against Downy Mildew

The transgenic cucumber plant transformed with JMT gene was inoculated with the causative organism of downy mildew (Pseudoperonospora cubensis) to investigate the effect of JMT gene on the resistance against causative pathogen of downy mildew in the plant body. Each of transgenic and wild-type cucumber plants was cultivated for 10 weeks and then inoculated with Pseudoperonospora cubensis by dividing leaves of cucumber infected with downy mildew into two and then applying them in the ratio of ½ leaf per one leaf of transgenic plant. As a result, it has been observed that after 2 weeks the wild-type plant occurred happened yellowish-brown spots starting from the edge of leaves and began to dry whereas the transgenic plant that consistently expresses JMT gene occurred only a slight spot (see Table 10). This finding suggests that the transgenic cucumber plant transformed with JMT gene has a resistance against downy mildew.

TABLE 10
Resistance of transgenic cucumber transformed with JMT
against downy mildew

| | Number of | | |
|---|---|---|---|
| | inoculated | Number of infected | Average area of |
| | leaves | leaves | lesions (%) |
| Non-transgenic | 10 | 8 | 50 |
| (wild-type) | | | |
| Trnasgenic | 10 | 4 | 10 |
| (JMT) | | | |

### EXAMPLE 17

### Investigation of Drought Resistance of Transgenic Arabidopsis Plant

The transgenic Arabidopsis plant transformed with JMT gene was investigated for the effect of JMT gene on a drought resistance of the plant body by stopping water supply for 2 weeks. Each of transgenic and wild type Arabidopsis plants was cultivated for 6 weeks and then water supply was stopped for 2 weeks. As a result, it has been observed that even though water supply was reopened, most of the wild-type plants has faded and died out whereas the transgenic plant that consistently expresses JMT gene exhibited a survival rate of about 65% (see Table 11). This finding suggests that the transgenic plant transformed with JMT gene has a resistance against water stress.

TABLE 11
Drought resistance of transgenic
Arabidopsis plant transformed with JMT

| | | Number of | Survival rate |
|---|---|---|---|
| | Number of plants | survival plants | (%) |
| Non-transgenic | 20 | 3 | 15 |
| (wild-type) | | | |
| Trnasgenic | 20 | 13 | 65 |
| (JMT) | | | |

### EXAMPLE 18

### Investigation of Salt Resistance of Transgenic Arabidopsis Plant

The transgenic Arabidopsis plant transformed with JMT gene was investigated for the effect of JMT gene on a salt resistance of the plant body by cultivating the plant at a high salt concentration. Each of transgenic and wild type Arabidopsis plants was germinated in MS medium supplemented with 300 mM salt. As a result, it has been observed that after one week the wild-type plant was substantially not germinated whereas the transgenic plant that consistently expresses JMT gene exhibited a germination rate of about 82% (see Table 12). This finding suggests that the transgenic plant transformed with JMT gene has a resistance against salt stress.

TABLE 12
Salt resistance of transgenic Arabidopsis plant transformed with JMT

| | | Number of | Germination rate |
|---|---|---|---|
| | Number of plants | Germinated plants | (%) |
| Non-transgenic | 100 | 8 | 8 |
| (wild-type) | | | |
| Trnasgenic | 100 | 82 | 82 |
| (JMT) | | | |

### EXAMPLE 19

### Investigation of Cold Resistance of Transgenic Arabidopsis Plant

The transgenic Arabidopsis plant transformed with JMT gene was investigated for the effect of JMT gene on a cold resistance of the plant body by cultivating the plant at low temperature. Transgenic and wild type Arabidopsis plants were placed in a refrigerator at 4° C. for one week and then analyzed for their survival rate after one week at 23° C. As a result, it has been observed that most of the wild-type plants could not recover and has faded and died out whereas the transgenic plant which consistently expresses JMT gene exhibited a survival rate of about 70% and grew relatively in a healthy state (see Table 13). This finding suggests that the transgenic plant transformed with JMT gene has a resistance against temperature stress of the plant body.

TABLE 13
Cold resistance of transgenic Arabidopsis plant transformed with JMT

| | Number of treated | Number of | Survival rate |
|---|---|---|---|
| | plants | survival plants | (%) |
| Non-transgenic | 10 | 1 | 10 |
| (wild-type) | | | |
| Trnasgenic | 10 | 7 | 70 |
| (JMT) | | | |

### INDUSTRIAL APPLICABILITY

A gene for jasmonic acid carboxyl methyltransferase of the present invention is a novel gene specifically expressed only in flowers of plants. By transforming the plant with an expression vector for plant transformation containing said gene, a transgenic plant which does not occur adverse effect on general growth properties of the plant and can effectively exhibit a high resistance against general fungal diseases, bacterial diseases, viral diseases or damages due to harmful insects, inter alia, blast, bacterial leaf blight, false smut and leafhopper in rice plant; scab in barley; brown spot in maize; mosaic disease in bean plant; mosaic disease in potato; late blight and anthracnose in red pepper; soft rot, root-knot disease and cabbage butterfly in Chinese cabbage and radish; bacterial blight in sesame; gray mold rot and wilt disease in strawberry; Fusarium wilt in watermelon; bacterial wilt in tomato; powdery mildew and downy mildew in cucumber; tobacco mosaic in tobacco; Fusarium wilt in tomato; root rot in ginseng; angular leaf spot in cotton plant; anthracnose and gray mold rot in fruit trees including apples, pears, peaches, kiwi fruit, grape and citrus; canker in apple; witches' broom in jujube tree; powdery mildew and rust in forage crops including ryegrass, red clover, orchard grass, alfalfa, etc.; gray mold rot and wilt disease in flowering plants including rose, gerbera, carnation, etc.; black spot in rose; mosaic disease in gladiolus and orchids; stem rot in lily, and the like can be obtained. Said transgenic plant also exhibits a high resistance against various stresses including low temperature, water deficiency, high salt concentration, etc. Thus, since the transgenic plant according to the present invention can exhibit a high resistance against plant diseases with reducing the use of agrochemicals, it can be expected that the transgenic plant can greatly contribute to an increase in yield of economical crops. Further, the present invention revealed that JaMe is involved mainly in the plant resistance against phytopathogens and harmful insects. According to this, it is expected that JMT gene and enzyme protein according to the present invention can be effectively utilized to search the novel jasmonic acid carboxyl methyltransferase and gene thereof in developing the plant body resistant to phytopathogens and harmful insects in the future.

What is claimed is:

1. A jasmonic acid carboxyl methyltransferase JMT having an amino acid sequence represented by Sequence ID No. 3.

2. A cDNA gene encoding jasmonic acid carboxyl methyltransferase as defined in claim 1.

3. The cDNA gene according to claim 2, which contains an amino acid sequence represented by Sequence ID No. 1.

4. The cDNA gene JMT according to claim 3, which contains an amino acid sequence represented by Sequence ID No. 2 (Accession No. KCTC 0794BP).

5. A recombinant vector for plant transformation, which contains the cDNA gene for jasmonic acid carboxyl methyltransferase as, defined in claim 2.

6. The recombinant vector pCaJMT for plant transformation according to claim 5, which contains a cDNA gene having a nucleotide sequence represented by Sequence ID No. 1.

7. A transgenic plant, which is transformed with the recombinant vector for plant transformation as defined in claim 5 and has an enhanced resistance against damages caused by phytopathogens and harmful insects and stresses.

8. A method for enhancing a resistance of plant against damages caused by phytopathogens and harmful insects and stresses, which comprises transforming the plant with a recombinant vector for plant transformation which contains a gene encoding jasmonic acid carboxyl methyltransferase.

9. The method according to claim 8, wherein the gene encoding jasmonic acid carboxyl methyltransferase is the gene as defined in claim 2.

10. The method according to claim 9, wherein the gene encoding jasmonic acid carboxyl methyltransferase is the gene as defined in claim 3 or 4.

11. The method according to claim 8, wherein the damages caused by phytopathogens and harmful insects are fungal diseases, bacterial diseases, viral diseases or damages due to harmful insects.

12. The method according to claim 11, wherein the damages caused by phytopathogens and harmful insects are blast, bacterial leaf blight, false smut and leafhopper in rice plant; scab in barley; brown spot in maize; mosaic disease in bean plant; mosaic disease in potato; late blight and anthracnose in red pepper; soft rot, root-knot disease and cabbage butterfly in Chinese cabbage and radish; bacterial blight in sesame; gray mold rot and wilt disease in strawberry; Fusarium wilt in watermelon; bacterial wilt in tomato; powdery mildew and downy mildew in cucumber; tobacco mosaic in tobacco; Fusarium wilt in tomato; root rot in ginseng; angular leaf spot in cotton plant; anthracnose and gray mold rot in fruit trees including apples, pears, peaches, kiwi fruit, grape and citrus; canker in apple; witches' broom in jujube tree; powdery mildew and rust in forage crops including ryegrass, red clover, orchard grass, alfalfa, etc.; gray mold rot and wilt disease in flowering plants including rose, gerbera, carnation, etc.; black spot in rose; mosaic disease in gladiolus and orchids; or stem rot in lily.

13. The method according to claim 8, wherein the plant to be transformed is selected from the group consisting of food crops, vegetable crops, crops for a special use, fruit trees, flowering plants and forage crops.

14. The method according to claim 13, wherein the food crop is selected from the group consisting of rice plant, wheat, barley, maize, potato, red-bean, oats and African millet; the vegetable crop is selected from the group consisting of Arabidopsis, Chinese cabbage, radish, red pepper, strawberry, tomato, watermelon, cucumber, cabbage, melon, pumpkin, green onion, onion and carrot; the crop for a special use is selected from the group consisting of ginseng, tobacco, cotton plant, sesame, sugar cane, sugar beet, green perilla, peanut and rape; the fruit tree is selected from the group consisting of apple tree, pear tree, jujube tree, peach tree, kiwi fruit, grape, citrus, persimmon tree, plum, apricot and banana; the flowering plant is selected from the group consisting of rose, gladiolus, gerbera, carnation, chrysanthemum, lily and tulip; and the forage crop is selected from the group consisting of ryegrass, red clover, orchard grass, alfalfa, tall fescue and perennial ryegrass.

15. The method according to claim 8, wherein the resistance against stresses is a drought resistance, a salt resistance and a cold resistance.
